(19) United States
(12) Patent Application Publication
(10) Pub. No.: US 2024/0371223 A1
(43) Pub. Date: Nov. 7, 2024

(54) ACCESS CONTROL APPARATUS AND METHOD

(71) Applicant: Ticketi UK Ltd, Manchester (GB)

(72) Inventor: Robert Monkman, Merseyside (GB)

(21) Appl. No.: 18/377,548

(22) PCT Filed: Apr. 8, 2022
(86) PCT No.: PCT/GB2022/050888

§ 371 Date: Oct. 6, 2023

(30) Foreign Application Priority Data
Apr. 6, 2021 (GB) 2105040.6

(51) Int. Cl. G07C 9/22; G06F 21/31

(52) U.S. Cl. CPC G07C 9/22; G06F 21/31

(57) ABSTRACT

An allocation method of allocating or not allocating a flag to a user which can be in turn be used to enable access by that user to a restricted area includes calculating a predicted score for the user using a pre-determined machine learning methodology, storing the predicted score in a database, calculating an eligibility score for the user based on the predicted score and an event coefficient, and if the eligibility score meets or exceeds a pre-determined threshold score, allocating a positive flag to the user in the database, otherwise allocating a negative flag to the user in the database.

### TECHNICAL FIELD

The present inventive concept relates to access control, for restricted areas and venues. Especially, the present inventive concept relates to access control in contexts when it is desirable to limit access to persons specifically identified ahead of time.

### BACKGROUND

It is well established to need to limit access to places for security and safety reasons. Workplaces and industrial establishments usually limit access to sites or to specific sub-divisions of sites to individuals with explicit permission to access them.

Certain establishments or venues may wish to offer public access—for example when an event is taking place—but to a limited number of people.

Traditionally, access control has been managed by the issue of physical tickets so that only a ticket-holder is allowed access to a restricted area. The number of people able to enter a restricted area is limited by issuing a suitably limited number of tickets.

However, a long-standing problem is that physical tickets can be illicitly duplicated—potentially leading to more people entering a restricted area than the safe capacity of that area. A further issue is that people or organizations can buy up significant numbers of tickets to then resell in the secondary market. This can lead to an organizer losing control over the people who have access to the restricted area. This could give rise to various problems. For example, people who might otherwise be banned from or unwelcome in a restricted area could gain access.

Attempts to digitize tickets have often been unable to overcome the issue of duplication and/or resale. There is therefore a need for an improved approach to access control.

### SUMMARY

The present inventive concept provides an allocation method of allocating or not allocating a flag to a user which can be in turn be used to enable access by that user to a restricted area, the method comprising the steps of:
calculating a predicted score for the said user using a pre-determined machine learning methodology;
storing the predicted score in a database;
calculating an eligibility score for the said user based on the predicted score and an event coefficient;
if the eligibility score meets or exceeds a pre-determined threshold score, allocating a positive flag to the said user in the database, otherwise allocating a negative flag to the said user in the database.

The term access permission is intentionally broad, because access permission can be demonstrated by a permitted person in a range of ways such as via a physical ticket bearing relevant information or by way of encoded information such as via a bar code or QR code or the like, or even a unique alpha-numeric code.

The event coefficient preferably depends on factors such as the number of access permissions which can be provided to the restricted area at a particular time, any age restrictions, whether there are different categories of access permission (e.g. standard, premium locations etc.).

The threshold score preferably depends on factors such as the number of other users seeking to obtain access permission to the restricted area at a particular time, and the like.

In effect, the method provides a way of profiling or scoring or assessing a user profile to determine whether that user should be able to obtain access permission.

The allocation method may further comprise the step of:
for a user having a positive flag in the database, providing a prompt to enable the said user to purchase access permission to a restricted area.

The said predicted score may be in the range between zero and 100. The predicted score is intended to rate the likelihood of a user being a so-called “ticket tout” or with some other negative intention—in contrast with a user who genuinely wishes to attend the restricted area.

The predicted score is calculated using a pre-determined machine learning methodology. The pre-determined machine learning methodology may use as input data a range of user preferences which the user has previously entered into the database.

The pre-determined machine learning methodology may be adapted to assess patterns within user preferences of a large number of users. Users who have previously become known for not genuinely wishing to attend the restricted area, or who have previously become known as ticket touts, or who have previously become known as having a negative intention may have their user preferences identified as training data.

In this description, the term access permission to a restricted area is used broadly. The term is intended to include venues such as music arenas, sports arenas, theatres, conference venues and the like. Such venues may provide time-limited events such as concerts, sports matches, and so on. There is therefore a physical location element and can also be a time-related element to the said access permission.

The present inventive concept also relates to a user method by which a user interacts with the allocation method as described above, the user method comprising the steps of:
the said user accesses an online web application from a device in their possession, such as a smart phone, personal computer or the like;
the said user can create a user account if they do not already have one; the user account is subsequently stored in the said database; the user account may comprise information such as the user's name, email address, other contact details, age, interests, relevant locations, and the like;
the said user must provide at least one biometric sample, such as a face scan, fingerprint or the like; the biometric sample is subsequently stored in the said database.

The user account information may be used as training data for the said machine learning methodology of the allocation method.

The present inventive concept also relates to a purchase method by which a user with a positive flag interacts with the allocation method as described above, the purchase method comprising the steps of:
for a user with a positive flag, the user can elect to purchase access permission to a restricted area or can elect to not purchase access permission to a restricted area;
if the user elects to purchase access permission to a restricted area, payment is taken and the details of the purchase are stored in the said database.

The details of the purchase can be accessible to the user via the said online web application.

The present inventive concept also relates to a validation method by which a user with a purchased access permission is validated at a particular point in time before entry into the restricted area, comprising the following steps:
the user is prompted to provide a contemporaneous biometric sample, such as a face scan, fingerprint or the like;
the contemporaneous biometric sample is compared with the user's biometric sample stored in the said database;
if the contemporaneous biometric sample matches the user's biometric sample stored in the said database, a positive match flag is returned for the user; an access permission code is transmitted to the user;
if the contemporaneous biometric sample does not match the user's biometric sample stored in the said database, a negative match flag is returned for the user; no access permission code is transmitted to the user.

The said particular point in time may be at a time which the user is unable to influence or control. The particular point in time, for example as considered as a point in time before the relevant access permission is valid for, may vary. This makes it more difficult for a user with non-genuine intentions to pass the access permission to another person after validation but before the validity of the access permission. In other words, this methodology makes it more difficult for a user to validate their ticket ahead of time and then sell it on to another person. The particular point in time may typically be on the days leading up to an event (i.e. when the access permission is valid) or on the day of the event itself.

The present inventive concept also relates to an entry method, comprising the following steps:
a user presents an access permission code to a reader;
if the said access permission code matches a code in the said database, entry to the restricted area is provided.

The present inventive concept also provides apparatus and related method for controlling access to a restricted area so that only pre-authorized persons are allowed to access the restricted area.

The said apparatus comprises an entry barrier adapted to selectively disallow or allow passage of a person into a restricted area, a reader of encoded data in communication with the entry barrier, the reader being adapted to receive said encoded data from a device adapted to display encoded data, that device being further adapted to identify a user of the device and adapted to compare the identity of the user to a pre-allocated identity of a person who has been approved for entry into the restricted area to determine a match or a non-match, the barrier being adapted to only allow a user to access the restricted area on determination of such an identification match, and wherein the identification of the user of the device and the comparison with the pre-allocated identity are carried out within a pre-determined time period before the suitable encoded data is read by the reader.

The said encoded data may be a bar code or a QR code or similar.

The present inventive concept provides a method of comparing the identity of a user of the said device adapted to display encoded data with a pre-allocated identity of a person who has been approved for entry into the said restricted area, wherein the method determines a match or a non-match, the method comprising the steps of:
identifying the user of the device by effecting hardware and software features of the device;
accessing a database containing information on the identities of persons allowed to enter the restricted area;
comparing the identity of the user of the device with the identities of persons allowed to enter the restricted area and determining whether the user is so allowed; and
returning a result of match or a non-match, accordingly.

Characteristics of the access permissions may include a location of access, a sub-division of the restricted area, a time of access or other factors.

The method may further comprise an allocation process for inserting into the said database suitable information relating to the identities of persons allowed to enter the restricted area, to provide the said pre-allocated identities.

The aim of the allocation process is to allocate a relatively limited number of access permissions to access the restricted area to a number of users. By way of example only, an event may take place within the restricted area in respect of which more people wish to attend than the capacity of the restricted area can accommodate. In the example of events, a situation often arises where access permission is bought up by professional intermediaries and then resold to end users. Various problems can arise from such a situation, including the event organizer not having sufficient information about the end users in order to operate the event safely or efficiently.

Thus it would be advantageous to provide a process which allocates access permission to specific users.

The allocation process may comprise the steps of enumerating access permissions, categorizing the access permissions into at least one category based on at least one characteristic of the access permissions, enumerating the number of potential users who might wish to have access permission, and offering access permission to a number of users according to one or more allocation criteria.

As set out above, characteristics of the access permissions may include a location of access, a sub-division of the restricted area, a time of access or other factors.

An essential characteristic may comprise a characteristic which is vital to be met in order to allow access permission. For example, an essential characteristic may include a user not being banned from access to the restricted area.

The allocation criteria may be selected from a group including but not limited to: user location, user accessibility requirements, user sub-division preferences, user travel preferences, user quantity preferences, and the like.

The allocation process may comprise an eligibility step of determining an eligibility status so that a Boolean status of “eligible” or “not eligible” is determined, wherein the eligibility step comprises comparing one or more access permission characteristics with allocation criteria and returning a status of “eligible” only if one or more essential characteristics are met by the relevant allocation criteria. Preferably, the said eligibility step returns a status of “eligible” only if all of the essential characteristics are met by the relevant allocation criteria.

Users for whom an eligibility status of “not eligible” is determined are thus excluded from the allocation process.

The allocation process may further comprise a scoring step of determining an eligibility score, for users for whom an eligibility status of “eligible” is determined, wherein the scoring step comprises applying one or more pre-determined coefficients to the allocation criteria of a user to generate a weighted result and adding together the said weighted results to provide an eligibility score.

The allocation process may further comprise an offer step, wherein a user is allocated one or more access permissions in accordance with their eligibility score and the number of available access permissions of a particular category.

The allocation process may comprise a confirmation step comprising communicating to a user the number of access permissions and their category or categories and requesting that the user confirms acceptance of the said number of access permissions and their category or categories. Preferably, the confirmation step must be completed within a pre-determined time period. If the confirmation step is not completed then the allocation process fails, and the relevant access permissions are not allocated to a user.

The confirmation step may further comprise requesting a suitable payment from the user.

The allocation process may comprise a reservation step, wherein after one or more preceding steps of the allocation process have been completed, one or more access permissions are flagged as reserved. The said one or more preceding steps may be the confirmation step.

The allocation process may comprise a sub-process in which a user (for clarity here labelled a lead user) can request a plurality of access permissions on behalf of that lead user and a number of other individuals. The lead user must be an existing user and must meet the requirements of the allocation process. Optionally a requirement may be made to ensure the other individuals are also existing users and meet the requirements of the allocation process in their own right. If the offer step of the process as described is reached on the part of one or more of the other users, the or each other user must complete the confirmation step on their own behalf. Nonetheless the lead user may opt to complete payment on behalf of one or more other users in order to proceed to the reservation step.

The allocation process may comprise an alternative sub-process in which a user can request a plurality of access permissions. The eligibility requirements may allow a user to request a plurality of access permissions and complete the process on behalf of other users. If a plurality of access permissions are allocated, a user need not complete the process for all access permissions. In other words, a user can optionally complete the process for fewer than the number allocated.

The method may also provide a de-allocation process for removing from the said database suitable information relating to the identities of persons allowed to enter the restricted area, to remove the said pre-allocated identities. The de-allocation process may be triggered, for example, if a user could not or did not want to enter the restricted area. The de-allocation process may comprise a step of flagging an access permission which was previously flagged as reserved so that it is subsequently flagged as available. The de-allocation process may further comprise a payment step in which a user is returned a payment in respect of the said access permission. An access permission which has been subsequently flagged as available may be allocated subsequently by the allocation as described.

### BRIEF DESCRIPTION OF THE DRAWINGS

Aspects of the disclosure herein will now be described, by way of example only, with reference to the accompanying figures, in which:

FIG. 1 is a schematic illustration of an example of the subject matter disclosed herein.

FIG. 2 shows further detail of the interaction between different parts of the machine learning methodology.

FIG. 3 shows a prior art allocation process.

FIG. 4 shows an exemplary implementation of the allocation process as described.

FIG. 5 shows an exemplary implementation of the de-allocation process as described.

### DETAILED DESCRIPTION

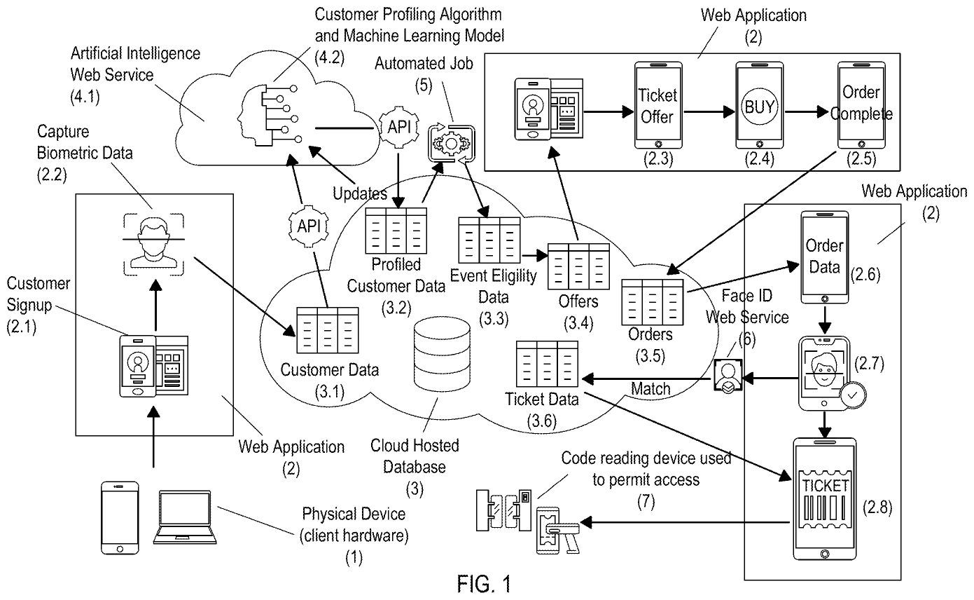

Envisaged embodiments of aspects of the inventive concept will now be described in further detail from a user's perspective. The following passages can be read in conjunction with FIG. 1.

### Step 1 (User Device)

User uses their own device (smart phone, laptop, etc) to access a web application.

### Step 2 (Web Application)

A user creates a user account via the web application and provide certain items of personal data, such as name, email address, etc.

### Step 3. (Capture Biometric Data)

The user provides one form of biometric data (face scan, fingerprint, etc) as a sample to complete the signup process.

### Step 4 (Database Entry)

Information provided by the user is entered into the database and stored in the customer table.

### Step 5 (AI Web Service)

At regular intervals, which may be for example daily, weekly, or triggered each time the user updates their information (profile), a set of specific data in passed to a machine learning methodology model to append their profile with a predicted score. The predicted score is calculated by using a set of inputs, which then uses a regression machine learning model to said inputs in order to produce a predicted score output within the range of between zero and 100 (a percentage). The predicted score ultimately provides a prediction on the likelihood of the user not genuinely wishing to attend the restricted area, of being a ticket tout or somebody with bad intentions etc.

The machine learning methodology can be further described as follows. An API message going from the database, for example from the profiled customer data and/or customer data to a web service where the model then performs machine learning methodology. This works based on data inputs, and then sends back a predicted score output—as described—wherein the score is a measure of the likelihood of the user not genuinely wishing to attend the restricted area, of being a ticket tout or somebody with bad intentions etc.

The predicted score output will be within the range of between zero and 100 (a percentage), and will be used toward determining if we then allow the use in due course to obtain a ticket or not (via sending the offer).

The inputs to this machine learning methodology API will be several information values, such as the user's age, interests, tastes, relevant locations, and the like. For example based on access to music events, the user's information may include one or more of the below factors:
number of artists in a wish-list of the user;
number of different musical genres indicated by the user;
number of events registered for;
number of tickets requested per event;
number of event date clashes (e.g. simultaneous events requested not at the same venue);
number of event location clashes (e.g. if a user requests access to venues with disparate locations, diverging with the user's own location).

The following table gives some exemplary data:

Machine Learning Breakdown
Inputs

| | | Example |
|---|---|---|
| Feature | Data Type | Value |
| Number of artists on user wishlist | Whole Number | 8 |
| Number of genre types | Whole Number | 2 |
| on customer wishlist | | |
| Number of events registrations | Whole Number | 3 |
| Average number of | Whole Number | 2.4 |
| tickets requested | | |
| Number of date/location clashes | Integer | 0 |
| | (whole number) | |

Output

| | | Value |
|---|---|---|
| Labels | Data Type | Range |
| Probability of being an unethical fan | Whole Number | 0-100 |

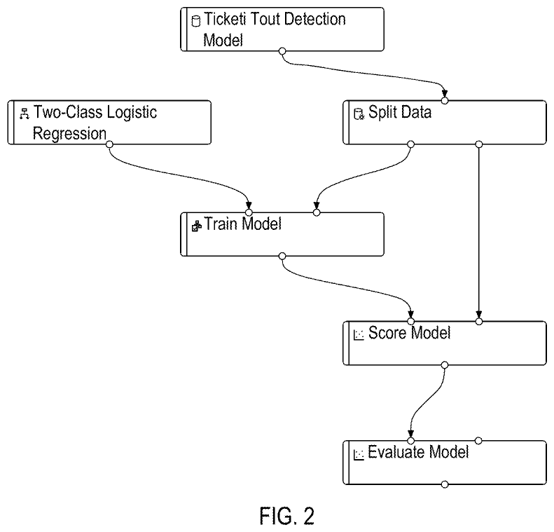

FIG. 2 shows further detail of the interaction between different parts of the machine learning methodology.

### Step 6 (Predicted Score Output)

The predicted score output is entered into the database and stored against to the user's profile in the customer table.

### Step 7 (Create Event Eligibility Data)

As tickets are due to go on sale for an event, user profile data is passed through an automated job which then creates an eligibility score for each user wishing to attend the event. This data is stored in the eligibility table. Each record is stored with the eligibility score produced from the automated job. This is effectively a way of ranking customers in the order in which they should be provided with the option to attend the event.

If the eligibility score meets or exceeds a pre-determined threshold score, allocating a positive flag to the said user in the database, otherwise allocating a negative flag to the said user in the database.

### Step 8 (Offer Data)

Based on whether a user has a positive flag, a personal offer record is created, which is stored in the Offers table, one record for each customer being given the option of purchasing access permission and in due course attending the event.

### Step 9 (User Offer Review)

All personal ticket offers are then linked to the appropriate user profile and presented to the user via the web application which is accessible from their personal device. The user will be presented with a screen to review the offer details.

### Step 10 (User Buys Ticket(s))

The user can then choose to buy the access permission (ticket(s)) or decline if they no longer want to attend the event.

### Step 11 (Order Complete)

The user makes the necessary payment, at which point the order is complete. Details of the order are then sent back to the database and stored as a record within the Orders table.

### Step 12 (View Order)

Details of the order can be accessed any time by the user who can use their device to access the web application.

### Step 13 (Biometric Input)

At a future particular point in time, and at a time the user is unable to influence or control, the user will use their device to access the web application and provide a biometric input, such as a face scan or fingerprint. This will typically be on the days leading up to an event or on the day of the event itself.

### Step 14 (Biometric Matching)

The biometric data provided by the user is submitted to a web service, via the web application, which then returns a match/non-match decision based on the biometric data held against the customer who was offered and bought the ticket. In the example shown in the diagram, this may be a face identification method.

### Step 15 (Ticket Code Set to Device)

If a valid biometric input was provided and a match result returned, the unique ticket code is sent back to the web application which the user can then access via their device. This data will be sent from the ticket data table held in the database, and the user is then presented with the code on their device.

### Step 16 (Code Scanning)

The user will then present their unique code, ready for it to be scanned by a handheld scanning device or a barrier entry point and entry will be permitted.

A further exemplary embodiment of the allocation process will now be described in further detail. In the below description, the term Fan is used to describe a user. The skilled reader will appreciate that a Fan is a user according to the terminology used in this specification.

A hypothetical event, Event A is scheduled to take place on a date in the future at a venue, Venue A. Venue A is a restricted area for safety reasons. Capacity at Venue A for Event A is limited to 20 people. More than 20 people may wish to attend Event A. Thus an access permission allocation process will need to be effected.

Access permissions are given a unique discrete reference, in this example T1001 to T1020. At the outset each discrete access permission is flagged as available. Each discrete access permission also has certain characteristics as described above, such as a sub-division of the restricted area. In this example, the sub-division is described as “standing”. Other possible sub-divisions might be a particular seat within the venue.

Event A is organized by Organization A. Organization A may have a following of a relatively large number of users who would like to attend their events when possible. Users who have identified themselves as followers of Organization A might be referred to as Fans.

Information about Fans is collected in a database. For example, Fans may have provided information about where they normally live, a distance they may be prepared to travel to an event, certain characteristics of access permission that they would require and/or prefer, as well as any other relevant information. As an example, Fan 1 may have provided their home location, a distance that they are prepared to travel to an event, and whether or they require an accessible seat, prefer a seat or to stand, and so on. Fan 1 has provided information that they would like six access permissions per event organized by Organization A.

Because there is excess demand for access permissions to Event A, an allocation process is effected.

An eligibility step is effected, which compares Fans' home location and distance they are prepared to travel to determine a status of “eligible” or “not eligible”. Thus, if the event is taking place in a location further away then a particular Fan's distance preferred to travel, that Fan will be deemed “not eligible”; if the event is taking place within a Fan's distance to travel then that Fan will be deemed “eligible”. In this way a pool of Fans who might be allocated access permission is prepared.

A user may be automatically “not eligible” if that user has been banned from access to the restricted area.

Within that pool of eligible Fans, in this example, the eligible Fans have requested more access permissions than the available number with the required ore preferred characteristics.

A scoring step is effected to provide a score to each Fan within the pool of eligible Fans. The scoring step comprises applying one or more pre-determined coefficients to the allocation criteria of a user to generate a weighted result and adding together the said weighted results to provide an eligibility score.

The Fan or Fans with the highest eligibility score are then offered a number of access permissions according to their request. If a particular Fan accepts the offer (and makes a payment as appropriate) within a pre-determined time period (e.g. 12 hours) then the relevant access permissions are flagged as reserved. If the particular Fan does not accept the offer, then the relevant access permissions are flagged as available, and the allocation process continues.

On arrival at Venue A, the user, Fan 1, must confirm their identity using their device before attempting to enter the restricted area. That confirmation of identity must be effected no more than a pre-determined time period before attempting to enter the restricted area. The identity of the user of the device is compared with the identity of the person to whom the access permission has been allocated previously. If the identity of the user matches the pre-allocated identity, then the device displays encoded data which is readable by a reader in communication with an entry barrier. On presentation of suitable encoded data to the reader, the entry barrier allows passage of the user into the restricted area. If the identity of the user does not match, or if the confirmation of the identity takes place too long before the presentation of the encoded data to the reader, then the entry barrier disallows passage of the user into the restricted area.

As described above, the allocation process may comprise a sub-process in which a user (for clarity here labelled a lead user) can request a plurality of access permissions on behalf of that lead user and a number of other individuals. The other individuals may be required to be existing users and to meet the requirements of the allocation process. If the offer step of the process as described is reached on the part of one or more of the other users, the or each other user must complete the confirmation step on their own behalf. Nonetheless the lead user may opt to complete payment on behalf of one or more other users in order to proceed to the reservation step.

Thus Fan 1 might wish to request access permissions for Fans 1, 2, 3 and 4. If all four fans are allocated access permission, then Fan 1 may optionally complete the payment step. On arrival at Venue A, at least Fan 1 must confirm their identity individually according to the above-described process. Optionally, Fans 2, 3 and 4 may be required to confirm their identity individually as described.

The allocation process may comprise an alternative sub-process in which a user can request a plurality of access permissions. The eligibility requirements may allow a user to request a plurality of access permissions and complete the process on behalf of other users.

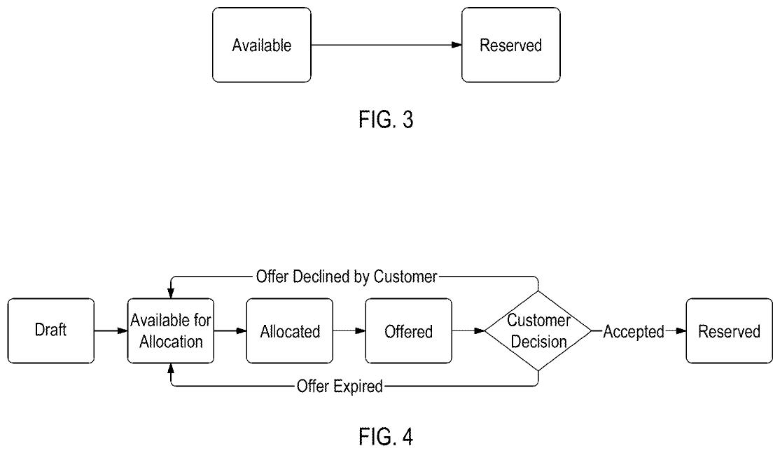

FIG. 3 of the accompanying drawings represents a prior art allocation process.

FIG. 4 shows an exemplary implementation of the allocation process as described.

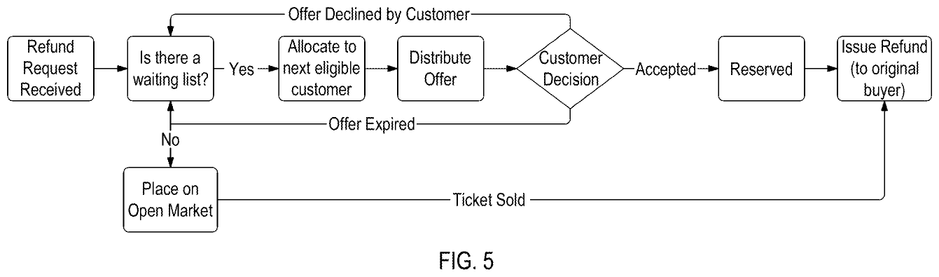

FIG. 5 shows an exemplary implementation of the de-allocation process as described.

1. An allocation method of allocating or not allocating a flag to a user which can be in turn be used to enable access by that user to a restricted area, the method comprising:
calculating a predicted score for the user using a pre-determined machine learning methodology;
storing the predicted score in a database;
calculating an eligibility score for the user based on the predicted score and an event coefficient; and
if the eligibility score meets or exceeds a pre-determined threshold score, allocating a positive flag to the user in the database, otherwise allocating a negative flag to the user in the database.

2. The allocation method according to claim 1, comprising:
for a user having a positive flag in the database, providing a prompt to enable the user to purchase access permission to a restricted area.

3. The allocation method according to claim 1, wherein the predicted score is in a range from zero to 100.

4. The allocation method according to claim 1, wherein the pre-determined machine learning methodology is configured to assess patterns within user preferences of a large number of users.

5. A user method by which a user interacts with the allocation method according to claim 1, the user method comprising:
the user accesses an online web application from a device in the user's possession;
the user can create a user account if the user does not already have one;
the user account is subsequently stored in the database;
the user account can comprise information including a name of the user, email address, contact details, age, interests, relevant locations;
the user must provide at least one biometric sample, which can be a face scan, fingerprint or another biometric sample;
the biometric sample is subsequently stored in the database.

6. A purchase method by which a user with a positive flag interacts with the allocation method according to claim 1, the purchase method comprising:
for a user with a positive flag, the user can elect to purchase access permission to a restricted area or can elect to not purchase access permission to a restricted area;
if the user elects to purchase access permission to a restricted area, payment is taken and details of the purchase are stored in the database.

7. A validation method by which a user with a purchased access permission is validated at a particular point in time before entry into a restricted area, comprising:
the user is prompted to provide a contemporaneous biometric sample, which can be a face scan, fingerprint or another biometric sample;
the contemporaneous biometric sample is compared with the user's biometric sample stored in the database;
if the contemporaneous biometric sample matches the user's biometric sample stored in the database, a positive match flag is returned for the user, and an access permission code is transmitted to the user;
if the contemporaneous biometric sample does not match the user's biometric sample stored in the database, a negative match flag is returned for the user, and no access permission code is transmitted to the user.

8. An apparatus for controlling access to a restricted area so that only pre-authorized persons are allowed to access the restricted area, the apparatus comprising an entry barrier configured to selectively disallow or allow passage of a person into a restricted area, a reader of encoded data in communication with the entry barrier, the reader being configured to receive the encoded data from a device configured to display encoded data, that device being configured to identify a user of the device and to compare the identity of the user to a pre-allocated identity of a person who has been approved for entry into the restricted area to determine a match or a non-match, the barrier being configured to only allow a user to access the restricted area on determination of an identification match, and wherein identification of the user of the device and the comparison with the pre-allocated identity are carried out within a pre-determined time period before the suitable encoded data is read by the reader.

9. A method for controlling access by the apparatus according to claim 8 to a restricted area so that only pre-authorized persons are allowed to access the restricted area, comprising comparing the identity of a user of the device configured to display encoded data with a pre-allocated identity of a person who has been approved for entry into the restricted area, wherein the method determines a match or a non-match, the method comprising:
identifying the user of the device by effecting hardware and software features of the device;
accessing a database containing information on the identities of persons allowed to enter the restricted area;
comparing the identity of the user of the device with the identities of persons allowed to enter the restricted area and determining whether the user is so allowed; and
returning a result of match or a non-match, accordingly.

10. The method according to claim 9, comprising an allocation process for inserting into the database suitable information relating to the identities of persons allowed to enter the restricted area, to provide the pre-allocated identities.

11. The method according to claim 10, wherein the allocation process comprises enumerating access permissions, categorizing the access permissions into at least one category based on at least one characteristic of the access permissions, enumerating the number of potential users who might wish to have access permission, and offering access permission to a number of users according to one or more allocation criteria.

12. The method according to claim 10, wherein the allocation process comprises an eligibility step of determining an eligibility status so that a Boolean status of “eligible” or “not eligible” is determined, wherein the eligibility step comprises comparing one or more access permission characteristics with allocation criteria and returning a status of “eligible” only if one or more essential characteristics are met by the relevant allocation criteria.

13. The method according to claim 12, wherein the eligibility step returns a status of “eligible” only if all of the essential characteristics are met by the relevant allocation criteria.

14. The method according to claim 12, wherein the allocation process further comprises a scoring step of determining an eligibility score, for users for whom an eligibility status of “eligible” is determined, wherein the scoring step comprises applying one or more pre-determined coefficients to the allocation criteria of a user to generate a weighted result and adding together the weighted results to provide an eligibility score.

15. The method according to claim 14, wherein the allocation process comprises an offer step, wherein a user is allocated one or more access permissions in accordance with their eligibility score and a number of available access permissions of a particular category.

16. The method according to claim 10, wherein the allocation process comprises a confirmation step comprising communicating to a user a number of access permissions and their category or categories and requesting that the user confirms acceptance of the number of access permissions and their category or categories.

17. The method according to claim 16, wherein the confirmation step must be completed within a pre-determined time period.

18. The method according to claim 16, wherein the confirmation step comprises requesting a suitable payment from the user.

19. The method according to claim 10, wherein the allocation process comprises a reservation step, wherein after one or more preceding steps of the allocation process have been completed, one or more access permissions are flagged as reserved.

20. The method according to claim 10, comprising a de-allocation process for removing from the database suitable information relating to the identities of persons allowed to enter the restricted area, to remove the pre-allocated identities.

21. The method according to claim 20, wherein the de-allocation process comprises flagging an access permission which was previously flagged as reserved so that it is subsequently flagged as available.
